(19) United States
(12) Patent Application Publication
(10) Pub. No.: US 2004/0202859 A1
(43) Pub. Date: Oct. 14, 2004

(54) Easy-to-use patch

(76) Inventor: Hae-Shang Sheu, Yung-Kang City (TW)

Correspondence Address: Chang Chla Wei, P.O. Box 25-7, Kaohsiung City, 811, TW

(21) Appl. No.: 10/420,274

(22) Filed: Apr. 11, 2003

(51) Int. Cl. B32B 5/02; B32B 27/04; B32B 27/12; B32B 7/12; B32B 15/04

(52) U.S. Cl. 428/343; 428/354

(57) ABSTRACT

A patch includes a support, an adhesive layer laminated on a face of the support, and a peeling film peelably attached to the adhesive layer. The peeling film includes two peeling film pieces that are connected by two connecting edges thereof. The connecting edges have a thinner and weaker structure than the remaining portions of the peeling film pieces. Alternatively, the connecting edges of the peeling film pieces are slightly bonded together. The respective peeling film pieces are easier to be peeled off from the adhesive layer, and the time for peeling is reduced. The risk of the user's hands in contact with the adhesive layer is greatly reduced. And the patch is easier to use for aged persons.

### BACKGROUND OF THE INVENTION

1. Field of the Invention

The present invention relates to an easy-to-use patch. In particular, the present invention relates to a patch including a support, an adhesive layer laminated on a face of the support, and a peeling film peelably attached to the adhesive layer.

2. Description of the Related Art

FIG. 1 of the drawings illustrates a conventional patch 1 including a support 13, an adhesive layer 11 laminated on a face of the support 13, and a peeling film 12 peelably attached to the adhesive layer 11. However, since the peeling film 12 covers most area of the adhesive layer, a relatively large resistance to peeling is generated and the user's hand is apt to be stuck with the adhesive layer 11 when peeling off the peeling film 12. Further, the peeling film 12 is often peeled off from one of the corners thereof, which is somewhat difficult to people with poor sight, especially aged persons.

### SUMMARY OF THE INVENTION

An object of the present invention is to provide a patch including a support, an adhesive layer laminated on a face of the support, and a peeling film peelably attached to the adhesive layer, wherein the peeling film can be easily removed from the adhesive layer.

A patch in accordance with the present invention includes a support, an adhesive layer laminated on a face of the support, and a peeling film peelably attached to the adhesive layer. The peeling film includes two peeling film pieces that are connected by two connecting edges thereof. The connecting edges have a thinner and weaker structure than the remaining portions of the peeling film pieces. Alternatively, the connecting edges of the peeling film pieces are slightly bonded together. The respective peeling film pieces are easier to be peeled off from the adhesive layer, and the time for peeling is reduced. The risk of the user's hands in contact with the adhesive layer is greatly reduced. And the patch is easier to use for aged persons.

Other objects, advantages, and novel features of the invention will become more apparent from the following detailed description when taken in conjunction with the accompanying drawings.

### BRIEF DESCRIPTION OF THE DRAWINGS

FIG. 1 is a perspective view of a conventional patch.

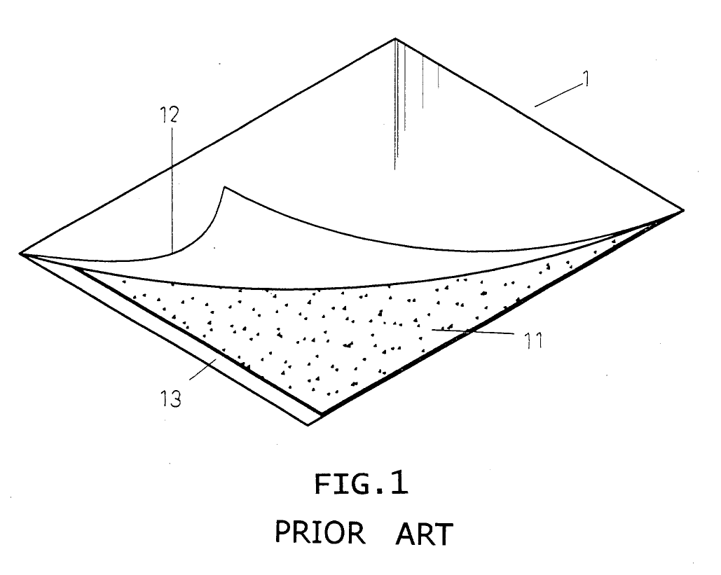

FIG. 2 is a perspective view of a patch in accordance with the present invention.

FIG. 3 is a perspective view illustrating peeling off of a peeling film of the patch in accordance with the present invention.

FIG. 4 is a view similar to FIG. 3, wherein the peeling film is torn apart from an intermediate portion.

FIG. 5 is an exploded perspective view of the patch in accordance with the present invention.

FIG. 6 is an exploded perspective view of a modified embodiment of the present invention.

### DETAILED DESCRIPTION OF THE PREFERRED EMBODIMENTS

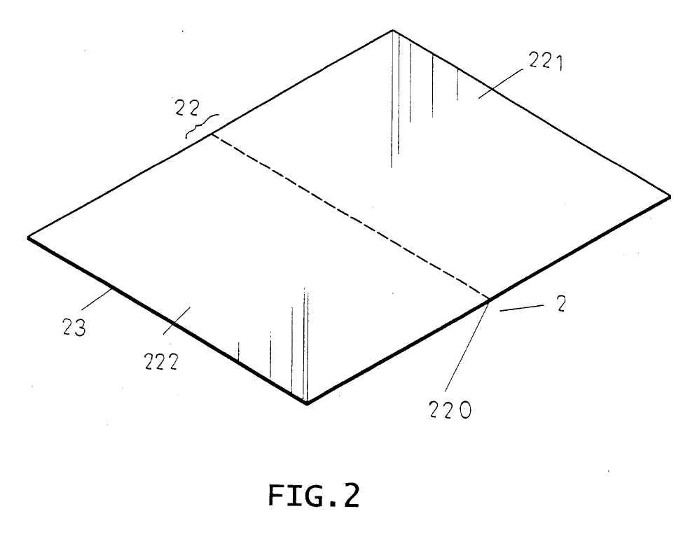

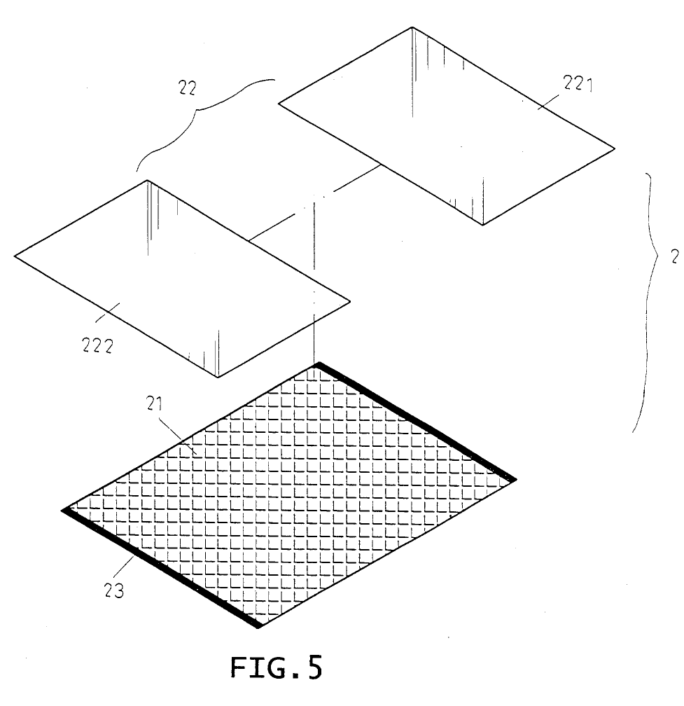

Referring to FIGS. 2 and 5, a patch 2 in accordance with the present invention generally comprises a support 23, an adhesive layer 21 laminated on a face of the support 23, and a peeling film 22 peelably attached to the adhesive layer 21.

Of more importance, the peeling film 22 includes two peeling film pieces 221 and 222 that are placed side by side and connected together along a common connecting line at their connecting edges 220. Thus, each peeling film piece 221, 222 covers a smaller area of the adhesive layer 21 when compared to the conventional design. Thus, the peeling film pieces 221 and 222 are easier to be peeled off from the adhesive layer 21, as the resistance to peel for the peeling off film pieces 221 and 222 is reduced. The connecting edges 220 of the peeling film pieces 221 and 222 have a thinner and weaker structure than the remaining portions of the respective peeling film pieces 221 and 222. Alternatively, the peeling film pieces 221 and 222 includes adhesive connecting edges 220 are slightly bonded together, allowing easy separation of the peeling film pieces 221 and 222. Further, the peeling film pieces 221 and 222 may not be disposed side by side, and they can be replaced with separate pieces that are equivalent in functions.

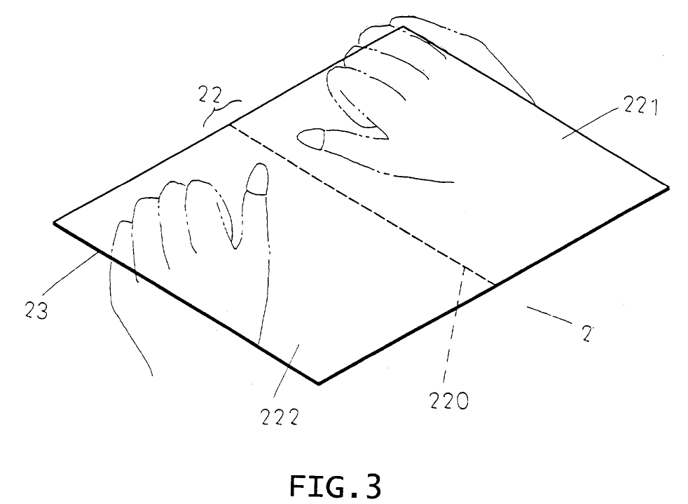

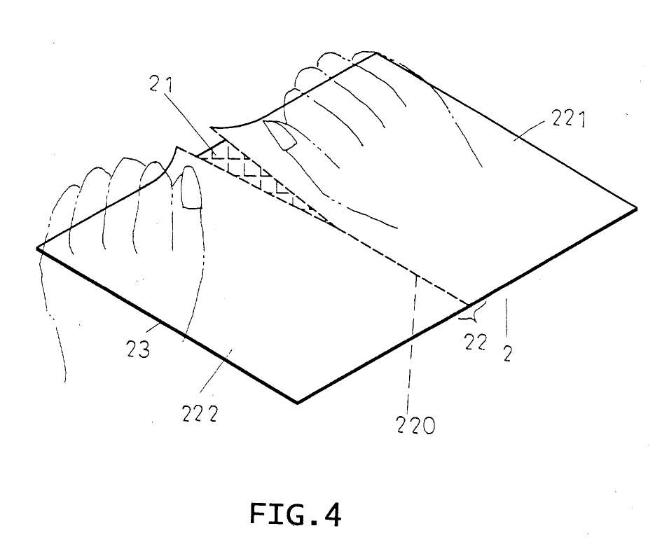

Referring to FIGS. 3 and 4, in use, two hands of a user respectively grasp the peeling film pieces 221 and 222 and apply opposite forces to overcome the bonding force between the, connecting edge 220 of the peeling film piece 221 and the connecting edge 220 of the peeling film piece 222 and to overcome the bonding force between the connecting edges 220 and the adhesive layer 21. Thus, the peeling film 22 is torn apart into pieces (i.e., the peeling film pieces 221 and 222) along the connecting edges 220, allowing removal of the peeling film pieces 221 and 222, as shown in FIG. 5.

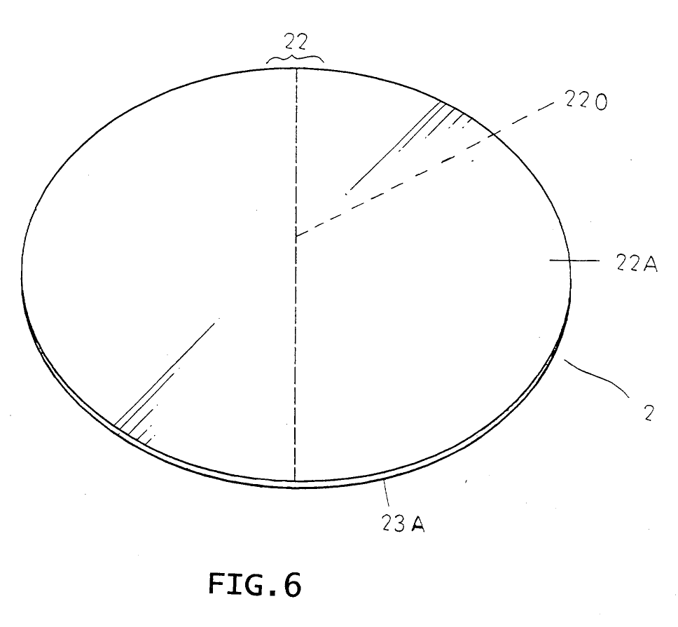

FIG. 6 illustrates a modified embodiment, wherein the peeling film 22 and the support 23 are circular, and the connecting edges 220 extend along a diameter of the circle.

According to the above description, it is appreciated that the respective peeling film pieces 221 and 222 are easier to be peeled off from the adhesive layer 21, and the time for peeling is reduced. The risk of the user's hands in contact with the adhesive layer 21 is greatly reduced. And the patch 2 is easier to use for aged persons.

Although the invention has been explained in relation to its preferred embodiment, it is to be understood that many other possible modifications and variations can be made without departing from the scope of the invention as hereinafter claimed.

What is claimed is:

1. A patch comprising:
a support;
an adhesive layer laminated on a face of the support; and
a peeling film peelably attached to the adhesive layer, the peeling film including two peeling film pieces that are connected by two connecting edges thereof.

2. The patch as claimed in claim 1, wherein the peeling film pieces are placed side by side.

3. The patch as claimed in claim 1, wherein the peeling film pieces are not placed side by side.

4. The patch as claimed in claim 1, wherein the peeling film and the support are circular.

5. The patch as claimed in claim 1, wherein the connecting edges have a thinner and weaker structure than remaining portions of the peeling film pieces.

6. The patch as claimed in claim 1, wherein the connecting edges of the peeling film pieces are slightly bonded together.
